(19) United States
(12) Patent Application Publication
(10) Pub. No.: US 2026/0300827 A1
(43) Pub. Date: Oct. 1, 2026

(54) AUTOMATED FAIRNESS EVALUATION AND AUDITING OF MACHINE LEARNING MODELS

(71) Applicant: Ohio State Innovation Foundation, Columbus, OH (US)

(72) Inventors: Aditya Vadlamani, Columbus, OH (US); Anutam Srinivasan, Columbus, OH (US); Pranav Maneriker, Columbus, OH (US); Srinivasan Parthasarathy, Columbus, OH (US)

(21) Appl. No.: 19/568,066

(22) Filed: Mar. 16, 2026

Related U.S. Application Data
(60) Provisional application No. 63/772,024, filed on Mar. 14, 2025.

(51) Int. Cl. G06N 20/00

(52) U.S. Cl. CPC G06N 20/00

(57) ABSTRACT

An example computer-implemented method of improving fairness of a conformal predictor associated with a machine learning model includes receiving a calibration set including a plurality of subgroups; receiving a fairness criterion; receiving a set of thresholds for generating prediction sets by the conformal predictor; iteratively determining whether a threshold from the set of thresholds balances coverage for each subgroup in the plurality of subgroups based on the fairness criterion; and outputting an optimal threshold from the set of thresholds;

### CROSS-REFERENCE TO RELATED APPLICATIONS

This application claims the benefit of U.S. provisional patent application No. 63/772,024, filed on Mar. 14, 2025, and titled “FAIRNESS EVALUATION AND AUDITING,” the disclosure of which is expressly incorporated herein by reference in its entirety.

### STATEMENT REGARDING GOVERNMENT SUPPORT

This invention was made with government support under 2112471 awarded by the National Science Foundation. The government has certain rights in the invention.

### BACKGROUND

Machine learning algorithms can be used to make decisions in many fields. Machine learning algorithms can be subject to biases that affect their performance. Examples of biases include biases based on historic outcomes, biases based on design choices, and biases based on the metrics used to train the model. Improvements to the measurement of bias in machine learning algorithms and/or their outputs can improve decision-making using machine learning algorithms.

### SUMMARY

In some aspects, implementations of the present disclosure include a computer-implemented method of improving fairness of a conformal predictor associated with a machine learning model, the method including: receiving a calibration set including a plurality of subgroups; receiving a fairness criterion; receiving a set of thresholds for generating prediction sets by the conformal predictor; iteratively determining whether a threshold from the set of thresholds balances coverage for each subgroup in the plurality of subgroups based on the fairness criterion; and outputting an optimal threshold from the set of thresholds.

In some aspects, implementations of the present disclosure include a computer-implemented method, wherein receiving the fairness criterion includes receiving a user selection of the fairness criterion.

In some aspects, implementations of the present disclosure include a computer-implemented method, further including outputting, to a user interface, at least one of (i) the optimal threshold or (ii) a measure of fairness corresponding to the optimal threshold.

In some aspects, implementations of the present disclosure include a computer-implemented method, wherein the fairness criterion includes a closeness criterion that defines an allowed disparity between subgroup-conditional coverages or subgroup-conditional miscoverages.

In some aspects, implementations of the present disclosure include a computer-implemented method, wherein iteratively determining whether the threshold balances coverage includes determining, for at least one label condition, a worst-case pairwise disparity in subgroup-conditional miscoverage or subgroup-conditional coverage across the plurality of subgroups and comparing the worst-case pairwise disparity to the closeness criterion.

In some aspects, implementations of the present disclosure include a computer-implemented method, wherein the fairness criterion includes disparate impact and the closeness criterion includes a ratio criterion comparing subgroup-conditional coverages between subgroups.

In some aspects, implementations of the present disclosure include a computer-implemented method, further including determining a plurality of classwise optimal thresholds that respectively correspond to different classes.

In some aspects, implementations of the present disclosure include a computer-implemented method, wherein iteratively determining whether the threshold balances coverage includes filtering the calibration set into a plurality of filtered calibration subsets based on a condition associated with the fairness criterion, the plurality of filtered calibration subsets including subsets corresponding to different subgroups, and wherein at least one subgroup includes an intersectional subgroup defined as a combination of values of multiple sensitive attributes.

In some aspects, implementations of the present disclosure include a computer-implemented method, further including: computing non-conformity scores for at least one filtered calibration subset using a non-conformity score function; and computing a subgroup-conditional miscoverage level for the threshold based on an inverse quantile evaluation of the non-conformity scores, wherein the non-conformity score function includes at least one of threshold prediction sets (TPS), adaptive prediction sets (APS), regularized adaptive prediction sets (RAPS), diffusion adaptive prediction sets (DAPS), or conformalized graph neural networks (CFGNN).

In some aspects, implementations of the present disclosure include a computer-implemented method, wherein the set of thresholds includes a threshold search space having a lower bound determined from a conformal quantile corresponding to a target miscoverage bound.

In some aspects, implementations of the present disclosure include a computer-implemented method, wherein the optimal threshold is selected to balance miscoverage between the plurality of subgroups.

In some aspects, implementations of the present disclosure include a computer-implemented method, wherein the optimal threshold is selected to minimize an average prediction set size.

In some aspects, implementations of the present disclosure include a computer-implemented method, further including receiving a plurality of fairness metrics, and wherein outputting the optimal threshold includes outputting a threshold that satisfies the plurality of fairness metrics.

In some aspects, implementations of the present disclosure include a computer-implemented method, wherein the fairness criterion corresponds to at least one of demographic parity, equal opportunity, predictive equality, equalized odds, predictive parity, disparate impact, or a user-defined fairness metric.

In some aspects, implementations of the present disclosure include a computer-implemented method, further including: receiving a trained machine learning model; calibrating or configuring a conformal predictor associated with the trained machine learning model using the optimal threshold; and operating the trained machine learning model in inference mode to output, for an input, a prediction set generated using the optimal threshold.

In some aspects, implementations of the present disclosure include a computer-implemented method, wherein the prediction set is generated using a single threshold without requiring subgroup membership information for the input during inference.

In some aspects, implementations of the present disclosure include a computer-implemented method for auditing fairness of a conformal predictor, the method including: receiving a fairness criterion; receiving a threshold used by the conformal predictor to generate prediction sets; receiving an audit dataset exchangeable with calibration data used by the conformal predictor; determining, using the audit dataset, whether the conformal predictor satisfies the fairness criterion at the threshold; and outputting an audit result indicating whether the fairness criterion is satisfied.

In some aspects, implementations of the present disclosure include a computer-implemented method, wherein determining whether the conformal predictor satisfies the fairness criterion is performed while treating the conformal predictor as a black box.

In some aspects, implementations of the present disclosure include a system including: a first computing device configured to operate a trained machine learning model in inference mode; a second computing device in operative communication with the first computing device, wherein the second computing device is configured to audit the trained machine learning model by: receiving a calibration set including a plurality of subgroups; receiving a fairness criterion; receiving a set of thresholds for generating prediction sets by a conformal predictor; iteratively determining whether a threshold from the set of thresholds balances coverage for each subgroup in the plurality of subgroups based on the fairness criterion; outputting an optimal threshold from the set of thresholds; calibrating or configuring a conformal predictor associated with the trained machine learning model using the optimal threshold; and operating the trained machine learning model in inference mode to output, for an input, a prediction set generated using the optimal threshold.

In some aspects, implementations of the present disclosure include a system, further including a display, wherein the second computing device is configured to output an indication of whether the trained machine learning model satisfies the fairness criterion.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a method of improving fairness of a conformal predictor associated with a machine learning model, according to implementations of the present disclosure.

FIG. 1B illustrates a method of for auditing fairness of a conformal predictor of a deployed machine learning model, according to implementations of the present disclosure.

FIG. 2 illustrates an example system including a deployed machine learning model according to implementations of the present disclosure.

FIG. 3 is an example computing device.

FIG. 4A illustrates plots of efficiency results for an example ACSincome dataset, according to a study of an example implementation of the present disclosure.

FIG. 4B illustrates plots of actual fairness disparity for an example ACSIncome dataset, according to a study of an example implementation of the present disclosure.

FIG. 5A illustrates plots of efficiency results for an example credit dataset, according to a study of an example implementation of the present disclosure.

FIG. 5B illustrates plots of actual fairness disparity for an example credit dataset, according to a study of an example implementation of the present disclosure.

FIG. 6A illustrates plots of efficiency results for an example Pokec-n dataset, according to a study of an example implementation of the present disclosure.

FIG. 6B illustrates plots of actual fairness disparity for an example Pokec-n dataset, according to a study of an example implementation of the present disclosure.

FIG. 7 illustrates an alternative plot of FIG. 5B which has a bar over each value of c rather than considering an average.

FIG. 8 illustrates an example end-to-end Conformal Fairness pipeline with three stages according to an implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations of the present disclosure refer to specific applications of machine learning, it will become evident to those skilled in the art that the implementations are not limited thereto, but are applicable for any type of fairness metric.

The term “artificial intelligence” is defined herein to include any technique that enables one or more computing devices or computing systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

Machine learning (ML) models are increasingly used to make critical decisions in many fields of human endeavor making it essential to quantify the uncertainty associated with their predictions. Conformal Prediction (CP) is a distribution-free framework (Vovk et al., 2005) which produces confidence sets with rigorous theoretical guarantees and has become popular in real-world applications (Cherian & Bronner, 2020). Post-hoc CP allows for facile integration into ML pipelines, while its weaker requirement of a statistical exchangeability assumption makes it applicable to a wide variety of data types, including graph data (H. Zargarbashi et al., 2023, Huang et al., 2024).

Relatedly, ensuring the fairness of machine learning models is vital for their high-stakes deployments in critical decision-making. Biases affect ML models at different stages—from data collection to algorithmic learning stages. During the data collection stage, measurement and representation biases can skew how each feature is interpreted, leading to inaccurate determinations by learning models. Algorithmic bias, caused by model design choices and prioritization of specific metrics while learning the model, can also lead to unfair outcomes. Many models inherit biases from historical outcomes and inadvertently skew decisions towards members of certain advantaged groups. These biases have led to several global actors proposing and requiring practitioners to adhere to certain fairness standards. To facilitate ML pipeline and model adherence to socio-cultural or regulatory fairness standards, researchers have proposed methods to either construct fair predictors or audit fairness claims made by deployed machine learning models.

However, these efforts on fairness (predictors, auditing, and uncertainty quantification) primarily focus on binary classification, often implicitly relying on the independent and identically distributed (IID) assumption, and do not, for the most part, bridge both fairness and uncertainty quantification. The need to both quantify uncertainty and ensure that fairness considerations are met is critical. A few researchers have started to examine how to assess (and possibly improve) the prediction quality of unreliable models (Wang & Wang, 2024) while meeting socio-cultural or regulatory standards of fairness. However, these efforts are limited in that they either require knowledge of group membership at inference time (a somewhat impractical assumption) or are model specific.

Described herein are systems and related methods for measuring fairness of machine learning models. As described herein, the systems and methods can include systems and methods for measuring and auditing the fairness of machine learning models, improving the fairness of such models, and visualizing the fairness of machine learning models.

The present disclosure includes a comprehensive Conformal Fairness (CF) Framework that addresses these and other limitations of conventional machine learning models and methods of auditing machine learning models.

Conformal prediction (CP) is a machine learning technique for quantifying uncertainty in machine learning models. Conformal prediction can provide probabilistic guarantees for the coverage of the true label (e.g., what is the likelihood that in a set of predictions the true label is present). However, conventional conformal prediction fails to account for subgroups within the dataset. This can prevent conformal prediction from being useful for machine learning that is applied to sensitive groups (e.g., demographic groups) because conventional conformal prediction methods do not consider subgroups of the dataset.

Implementations of the present disclosure include systems and methods that improve conformal prediction by ensuring that conformal prediction performs well on subgroups in the dataset, not just the dataset as a whole. This allows for conformal prediction to provide fair outputs in datasets with subgroups. Because subgroups are common in real-world datasets (e.g., datasets including demographic information) this allows machine learning to be fairly applied to real-world datasets including subgroups.

First, the present disclosure presents the methods that enable Conformal predictions distribution-free approach to build and construct fair uncertainty sets according to user-specified notions of fairness. The methods described herein are not only comprehensive but also highly flexible, as they can be adapted to bespoke user-specified fairness criteria. This adaptability ensures that the framework can be customized to meet the specific needs of different users, enhancing its practicality and usability.

Second, the weaker (exchangeability) assumptions required by CP allow the present disclosure to extend the utility of the framework to fairness problems in graph models. Graph models, in particular, suffer from the homophily effect, which exacerbates inherent segregation due to node linkages and causes further biases in predictions.

Third, the present disclosure includes a fairness auditing tool for conformal predictors. This function is important as it allows one to verify the fairness of the model, ensuring that fairness is not just a theoretical concept but a practical reality in predictive modeling.

Fourth, the present disclosure demonstrates the effectiveness of the CF Framework by evaluating fairness using multiple popular fairness metrics for multiple different conformal predictors on both real-world graph and tabular fairness datasets.

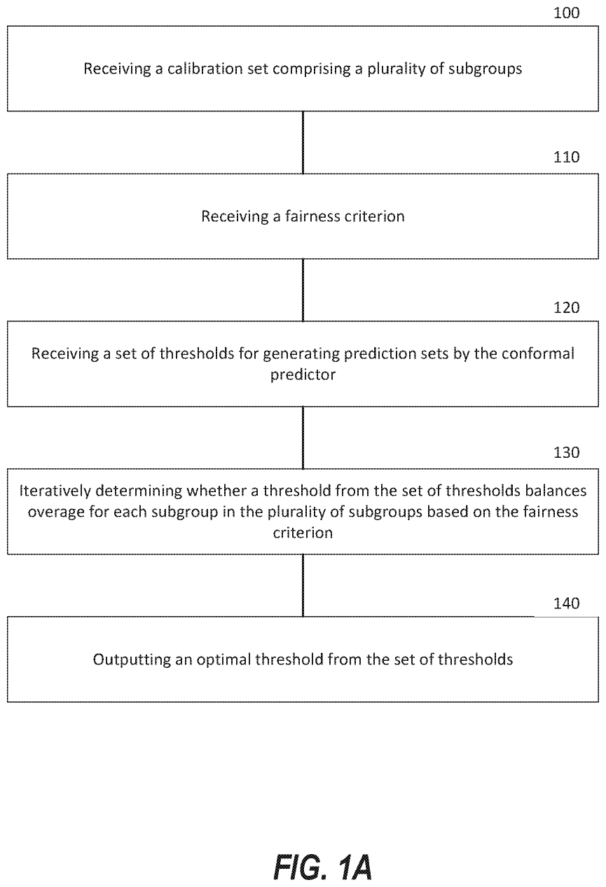

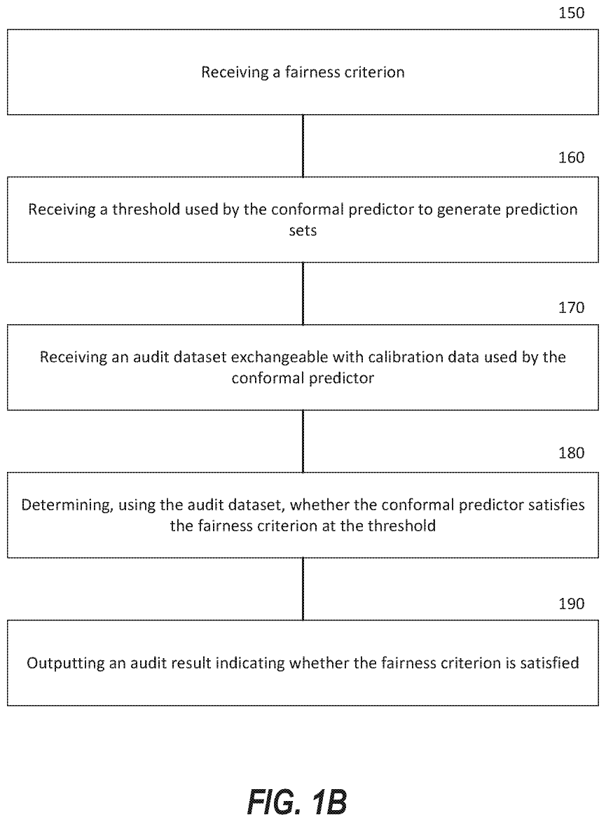

With reference to FIG. 1A, a computer-implemented method for improving fairness of a conformal predictor associated with a machine learning model is shown.

At step 100 the method includes receiving a calibration set comprising a plurality of subgroups.

At step 110 the method includes receiving a fairness criterion. Optionally, the method can further include receiving a user selection of a fairness criterion, or a user definition of a fairness criterion. Optionally, the fairness criterion can include a closeness criterion that defines an allowed disparity between subgroup-conditional coverages or subgroup-conditional miscoverages. Alternatively or additionally, the fairness criterion can include disparate impact, and the closeness criterion comprises a ratio criterion comparing subgroup-conditional coverages between subgroups. Alternatively or additionally, the fairness criterion can correspond to at least one of demographic parity, equal opportunity, predictive equality, equalized odds, predictive parity, disparate impact, or a user-defined fairness metric.

At step 120 the method includes receiving a set of thresholds for generating prediction sets by the conformal predictor.

At step 130 the method includes iteratively determining whether a threshold from the set of thresholds balances coverage for each subgroup in the plurality of subgroups based on the fairness criterion. Optionally, iterations can include determining, for at least one label condition, a worst-case pairwise disparity in subgroup-conditional miscoverage or subgroup-conditional coverage across the plurality of subgroups and comparing the worst-case pairwise disparity to the closeness criterion.

Alternatively or additionally, the iterations can include filtering the calibration set into a plurality of filtered calibration subsets based on a condition associated with the fairness criterion, the plurality of filtered calibration subsets including subsets corresponding to different subgroups, and wherein at least one subgroup comprises an intersectional subgroup defined as a combination of values of multiple sensitive attributes.

At step 140 the method includes outputting an optimal threshold from the set of thresholds. Optionally, the optimal threshold can be selected to balance miscoverage between the plurality of subgroups. In some implementations, the method can further include receiving a plurality of fairness metrics (e.g., by a user interface), and outputting a threshold that satisfies the plurality of fairness metrics.

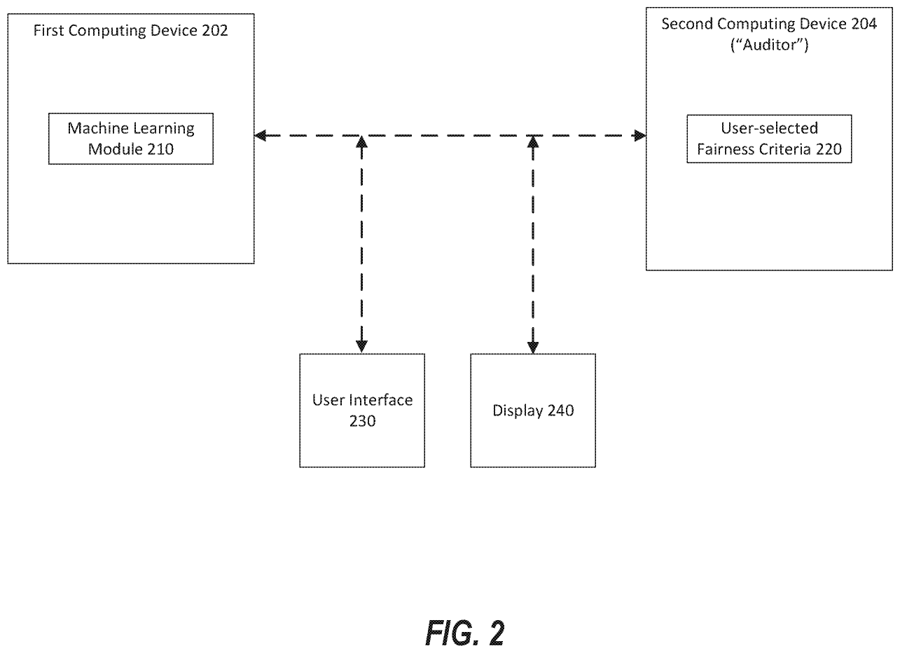

Optionally, the method can further include outputting, to a user interface, at least one of (i) the optimal threshold or (ii) a measure of fairness corresponding to the optimal threshold. Additional description of example user interfaces is provided with reference to FIG. 2, for example.

Alternatively or additionally, the optimal threshold can be selected to minimize an average prediction set size.

Optionally, the method shown in FIG. 1A can further include computing non-conformity scores for at least one filtered calibration subset using a non-conformity score function and computing a subgroup-conditional miscoverage level for the threshold based on an inverse quantile evaluation of the non-conformity scores. The non-conformity score function can optionally include at least one of threshold prediction sets (TPS), adaptive prediction sets (APS), regularized adaptive prediction sets (RAPS), diffusion adaptive prediction sets (DAPS), or conformalized graph neural networks (CFGNN). Optionally, the prediction set can be generated using a single threshold without requiring subgroup membership information for the input during inference.

In some implementations, the set of thresholds can include a threshold search space having a lower bound determined from a conformal quantile corresponding to a target miscoverage bound.

Optionally, the method shown in FIG. 1A can further include receiving a trained machine learning model, calibrating or configuring a conformal predictor associated with the trained machine learning model using the optimal threshold, and operating the trained machine learning model in inference mode to output, for an input, a prediction set generated using the optimal threshold.

With reference to FIG. 1B, implementations of the present disclosure further include methods for auditing fairness of a conformal predictor.

At step 150, the method includes receiving a fairness criterion;

At step 160, the method includes receiving a threshold used by the conformal predictor to generate prediction sets;

At step 170, the method includes receiving an audit dataset exchangeable with calibration data used by the conformal predictor.

At step 180, the method includes determining, using the audit dataset, whether the conformal predictor satisfies the fairness criterion at the threshold. Optionally, step 180 can be performed while treating the conformal predictor as a black box.

At step 190, the method includes outputting an audit result indicating whether the fairness criterion is satisfied.

FIG. 2 illustrates an example system that can be used to implement the methods described herein, including with reference to FIGS. 1A-1B.

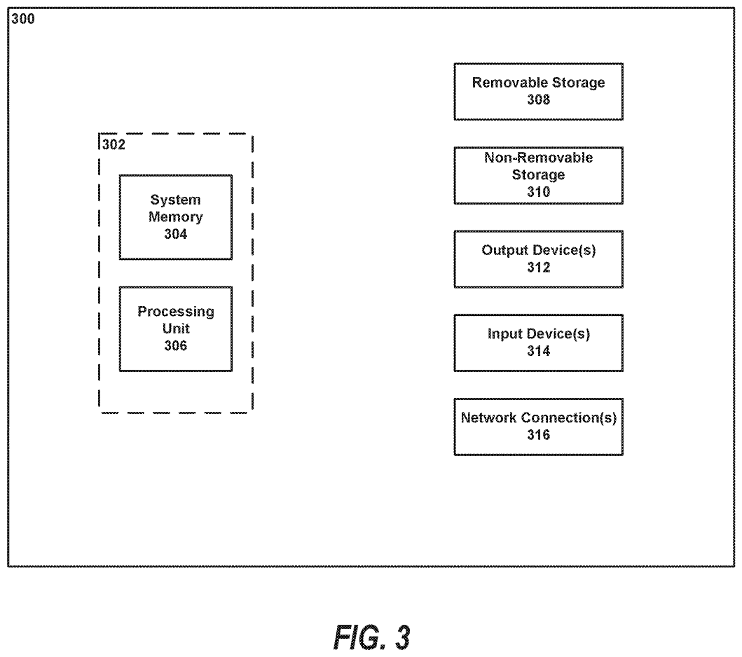

The system can include a first computing device 202 and a second computing device 204. The first computing device 202 and second computing device 204 can optionally include any of the features of the example computing device shown in FIG. 3.

The first computing device 202 can be configured to operate a trained machine learning model 210 in inference mode, for example by storing the trained machine learning model 210 in one or more memories, and/or by operating the machine learning module on hardware configured for operating machine learning models in inference mode (e.g., one or more graphics processor units, AI processor units, integrated memory modules, etc.).

The second computing device 204 can be in operative communication with the first computing device 202 through any combination of wired and/or wireless networks.

The second computing device 204 can be configured to perform the methods described herein, for example with reference to FIGS. 1A and 1B to audit the fairness of the machine learning model 210 using user-selected fairness criteria 220 stored in a memory of the second computing device. For example, the second computing device can include one or more processors and one or more memories configured to implement the methods described with reference to FIGS. 1A and 1B.

The system can optionally include a user interface 230 that can be used to receive one or more fairness criteria from a user. The system can further optionally include a display 240 configured to output the results of any of the methods described herein, including, for example, the threshold that satisfies a plurality of the fairness metrics. The user interface 230 and display 240 can optionally be in operative communication with the first computing device 202 and second computing device 204 through any combination of wired and/or wireless networks.

The method shown in FIG. 1A and FIG. 1B can be used to ensure the fairness of a machine learning model. For example, a trained machine learning model can be evaluated according to the methods of FIGS. 1A-1B, and the fairness of the machine learning model can be output. As another example implementation, a machine learning model can be calibrated based on the optimal threshold determined according to the method of FIGS. 1A and 1B, and the calibrated machine learning model can then be operated in inference mode. By calibrating the machine learning model according to the methods described herein, the inference mode of the machine learning model can configured to be fair across subgroups used at inference time.

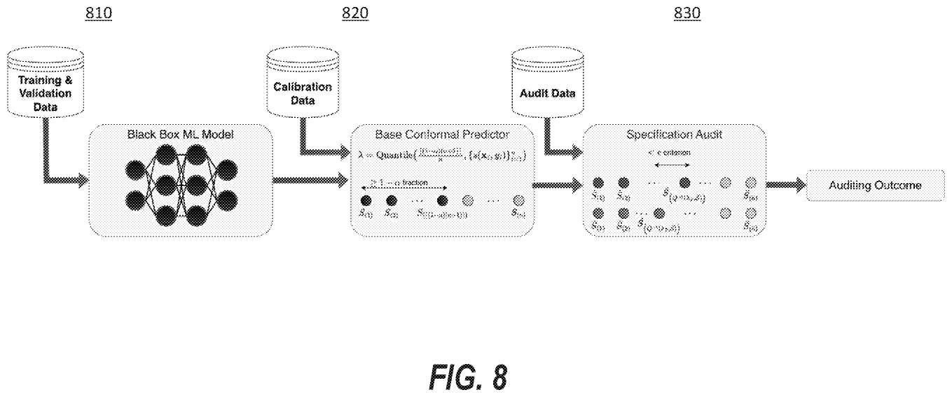

FIG. 8 illustrates another example of a method according to the present disclosure. The example shown in FIG. 8 includes an end-to-end Conformal Fairness pipeline with three stages. In a model development stage 810, a classification model is trained and tuned using training and validation datasets. In a conformal calibration stage 820, a separate calibration dataset is used to construct a conformal predictor, which is then deployed for downstream decision-making. In a post-deployment auditing stage 830, a separate auditing dataset is used to evaluate the deployed predictor against specified fairness audit criteria at any point after deployment.

It should be appreciated that the logical operations described herein with respect to the various figures may be implemented (1) as a sequence of computer-implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well-known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer-readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Conformal Prediction

Conformal Prediction is a framework for quantifying the uncertainty of a model by constructing prediction sets that satisfy a miscoverage guarantee. For expository simplicity, the present example will focus on split (or inductive) conformal prediction (CP) in the classification setting, however it should be understood that the present disclosure is not so limited. Given a calibration dataset,

$${𝒟}_{calib} = {\{ ( {x}_{i} , {y}_{i} ) \}}_{i = 1}^{n}$$

and a test point (xₙ₊₁, yₙ₊₁), where xᵢ ∈ X= [symbol] ^{d} and yᵢ ∈ [symbol] ={0, . . . , K−1}, CP is used to construct a prediction set [symbol] (xₙ₊₁) such that:

$$α - \frac{1}{n + 1} < P r [ {y}_{n + 1} ∉ {𝒞}_{\hat{q} ( a )} ( {x}_{n + 1} ) ] \leq α , \qquad ( 1 )$$

where α ∈ [0,1] is the miscoverage bound. Concretely, given a non-conformity score function s: [symbol] × [symbol] → [symbol] , let

$$\hat{q} ( α ) = Quantile ( \frac{[ ( n + 1 ) ( 1 - α ) ]}{n} ; {\{ s ( {x}_{i} , {y}_{i} ) \}}_{i = 1}^{n} ) .$$

Then, [symbol] _{\hat{q}(α)}(xₙ₊₁)={y∈ [symbol] : s(x, y)≤\hat{q}(α)} satisfies Equation 1. Evaluating CP: Coverage quantifies the true test time probability Pr[yₙ₊₁ ∈ [symbol] _{\hat{q}(α)} (xₙ₊₁) while efficiency is the average test prediction set size, | [symbol] (xₙ₊₁)|. Intuitively, there is an inverse relationship between coverage and efficiency, as a higher desired coverage is harder to achieve so the method may produce larger prediction sets to satisfy the guarantee. In CP, the only assumption made about the data is that [symbol] _{calib} ∪ {(xₙ₊₁, yₙ₊₁)} is exchangeable—a weaker notion than iid, enabling its use on non-iid data, including graph data.

Graph CP: The present disclosure focuses on the node classification task. Given an attributed graph [symbol] =(V, ε, X), where V is the set of nodes, ε is the set of edges, and X is the set of node attributes. Let A be the adjacency matrix for the graph. Further, let [symbol] ={0, . . . , K−1} denote the set of classes associated with the nodes. For v ∈ V, xᵥ ∈ [symbol] ^{d} denotes its features and yᵥ ∈ [symbol] denotes its true class. The task of node classification is to learn a model that predicts the label for each node given node features and the adjacency matrix, i.e. (X, A, v)→yᵥ. In the transductive setting, the entire graph, including test points, is accessible during the base model training. In this scenario, for any trained permutation-equivariant function (e.g. GNN) trained on a set of training/validation nodes, the scores produced on the calibration set and test set are exchangeable, thus enabling CP to be applied.

### Fairness Metrics

Group (or statistical) fairness require that individuals from different sensitive groups be treated equally. Sensitive groups are defined to subpopulations characterized by sensitive attribute(s) including gender, race, and/or ethnicity. Group fairness metrics aim to observe bias in the predictions of a model between the different groups in a dataset. The present disclosure considers several fairness metrics, including equal opportunity, equalized odds, demographic parity, predictive equality, and predictive parity. For generality, the present disclosure defines the metrics for the multiclass setting with an n-ary sensitive attribute. Let [symbol] ⁺ denote the set of advantaged labels (e.g., “is_approved” in a loan approval task), Y be the true label, and Ŷ be the predicted label from a classifier. Let [symbol] be the set of all groups for the sensitive attribute(s). Formally, for Demographic Parity, we may require that for some (small) c ∈ (0,1],

$${max}_{\tilde{y} ∈ {𝓎}^{+}} \{ \vert Pr [ \hat{Y} = \tilde{y} \vert X ∈ {g}_{a} ] - P r [ \hat{Y} = \tilde{y} \vert X ∈ {g}_{b} ] \vert \vert ∀ {g}_{a} , {g}_{b} ∈ 𝒢 \} < c .$$

Similar requirements exist for the other fairness metrics.

Table A1 discusses the formal definitions of different fairness metrics considered in the present disclosure.

TABLE A1
Fairness metrics formulations for multiclass classification.

| Metric | Definition |
|---|---|
| Demographic (or Statistical) | Pr[Ŷ = y \| X ∈ gₐ] = |
| Parity | Pr[Ŷ = y \| X ∈ g_{b}], ∀gₐ, g_{b} ∈ [symbol] , |
| | ∀y ∈ [symbol] ⁺ |
| Equal Opportunity | Pr[Ŷ = y \| Y = y, X ∈ gₐ] = |
| | Pr[Ŷ = y \| Y = y, X ∈ g_{b}], ∀gₐ, g_{b} |
| | ∈ [symbol] , ∀y ∈ [symbol] ⁺ |
| Predictive Equality | Pr[Ŷ = y \| Y ≠ y, X ∈ gₐ] = |
| | Pr[Ŷ = y \| Y ≠ y, X ∈ g_{b}], ∀gₐ, g_{b} |
| | ∈ [symbol] , ∀y ∈ [symbol] ⁺ |
| Equalized Odds | Equal Opp. and Pred. Equality |
| Predictive Parity | Pr[Y = y \| Ŷ = y, X ∈ gₐ] = |
| | Pr[Y = y \| Ŷ = y, X ∈ g_{b}], ∀gₐ, g_{b} |
| | ∈ [symbol] , ∀y ∈ [symbol] ⁺ |

Achieving exact fairness (i.e., equality in Table A1) can be challenging and, in some cases, impossible. Often, regulatory requirements focus on the differences in probabilities between groups for any given positive label. For example, while exact Demographic Parity is challenging to achieve, many regulatory bodies instead focus on Disparate Impact. Disparate Impact considers the ratio between the groups-rather than the difference.

### Conformal Fairness (CF) Framework

The example implementation further includes methods using conformal predictors to control for fairness disparity between different sensitive groups. The framework is motivated by adapting the standard CP algorithm to determine conditional miscoverage given a score threshold, λ, for the prediction sets (i.e. [symbol] _{λ}(xₙ₊₁)={y ∈ [symbol] |s(xₙ₊₁, yₙ₊₁)≤λ}. Depending on the fairness metric, fairness disparity refers to gaps in group-conditional or group-and-class-conditonal coverages between groups and advantaged labels. The conditional coverages are leveraged to evaluate if fairness is achieved for some closeness criterion c for different fairness metrics. This is achieved by searching a threshold space A for an optimal threshold λₒₚₜ that achieves the closeness criteria. The framework also handles user-defined metrics as discussed herein, thus controlling for quantities, potentially orthogonal to conditional coverage.

### Exemplar Conformal Fairness (CF) Metrics

For conformal fairness, the example implementation adapted popular fairness metrics defined for multiclass classification (shown in Table A1). For standard point-wise predictions, fairness measures are concerned with the probability a prediction is a specific label (i.e., \tilde{y}=Ŷ), given a condition, i.e., X ∈ gₐ, Y=\tilde{y} for Equal Opportunity, for a particular covariate (X, Y). The example implementation can replace equivalence to the predicted value with set membership (\tilde{y} ∈ [symbol] _{λ}(X)) to adapt these notions for prediction sets. The adapted conformal fairness metrics are in Table 1.

TABLE 1
Conformal Fairness Metrics.

| Metric | Definition |
|---|---|
| Demographic (or | Pr[\tilde{y} ∈ [symbol] _{λ} (X) \| X ∈ gₐ] = |
| Statistical) Parity | Pr[\tilde{y} ∈ [symbol] _{λ} (X) \| X ∈ g_{b}], |
| | ∀gₐ, g_{b} ∈ [symbol] , ∀\tilde{y} ∈ [symbol] ⁺ |
| Equal Opportunity | Pr[\tilde{y} ∈ [symbol] _{λ} (X) \| Y = \tilde{y}, X ∈ gₐ] = |
| | Pr[\tilde{y} ∈ [symbol] _{λ} (X) \| Y = \tilde{y}, X ∈ g_{b}] ∀gₐ, g_{b} |
| | ∈ [symbol] , ∀\tilde{y} ∈ [symbol] ⁺ |
| Predictive Equality | Pr[\tilde{y} ∈ [symbol] _{λ} (X) \| Y + \tilde{y}, X ∈ gₐ] = |
| | Pr[\tilde{y} ∈ [symbol] _{λ} (X) \| Y + \tilde{y}, X ∈ g_{b}], ∀gₐ, g_{b} |
| | ∈ [symbol] , ∀\tilde{y} ∈ [symbol] ⁺ |
| Equalized Odds | Equal Opp. and Pred. Equality |
| Predictive Parity | Pr[Y = \tilde{y} \| \tilde{y} ∈ [symbol] _{λ} (X), X ∈ gₐ] = |
| | Pr[Y = \tilde{y} \| \tilde{y} ∈ [symbol] _{λ} (X), X ∈ g_{b}], ∀gₐ, g_{b} |
| | ∈ [symbol] , ∀\tilde{y} ∈ [symbol] ⁺ |

### Conformal Fairness (CF) Methodology

For ease of exposition, the present disclosure may equivalently control for either coverage or miscoverage. Filtering [symbol] _{calib}: Group fairness metrics are evaluated on a subset of the population, defined by a condition on the data (i.e., membership in a group, true label value). For example, Demographic Parity is evaluated per group (X ∈ gₐ in definition), while Equal Opportunity is evaluated per group and true label (Y=y, X ∈ gₐ in definition). To formalize this notion, let M denote a fairness metric (e.g. Equal Opportunity) and define F_{M}: [symbol] × [symbol] × [symbol] × [symbol] ⁺→{0,1} a filter function which maps a calibration point along with a group and positive label, (xᵢ, yᵢ, g, \tilde{y}), to 0 or 1 depending on whether the condition for the fairness metric, M, is satisfied. For Equal Opportunity, F_{M} would instantiate to F_{EO} (xᵢ, yᵢ, g, \tilde{y}):=1[xᵢ ∈ g ∩ yᵢ=\tilde{y}]. [symbol] _{calib} can be filtered to be [symbol] _{calib (g,\tilde{y})}={(xᵢ, yᵢ) ∈ [symbol] _{calib}|F_{M} (xᵢ, yᵢ, g, \tilde{y})=1}. By doing so, the example implementation provides guarantees regarding the conditional miscoverages. For any (g, \tilde{y}) ∈g× [symbol] ⁺, calibrating on [symbol] _{calib (g,\tilde{y})} guarantees the following about the conditional coverage:

$$α - \frac{1}{\vert {𝒟}_{calib ( g , y )} \vert + 1} < P r [ {y}_{n + 1} ∉ {𝒞}_{λ} ( {x}_{n + 1} ) \vert {F}_{M} ( {x}_{n + 1} , {y}_{n + 1} , g , \tilde{y} ) = 1 ] \leq α \qquad ( 2 )$$

The interval_width is

$$\frac{1}{\vert {𝒟}_{calib ( g , y )} \vert + 1} .$$

Prior work focused on the upper bound; however, the lower bound is also necessary for the framework described herein. Inverse Quantile: Given an α-miscoverage level, the (1−α)-quantile of the calibration non-conformity scores is the appropriate threshold to achieve Equation 1. Given a threshold, λ, the example implementation can recover the miscoverage level. This can be done using the inverse λ-quantile. Formally, if (xₙ₊₁, yₙ₊₁) is a test point and [symbol] _{calib}={s(xᵢ, yᵢ)|(xᵢ, yᵢ) ∈ [symbol] _{calib}}, the inverse λ-quantile is given by:

$${Q}^{- 1} ( λ , {𝒮}_{calib} ) := Pr [ s ( {x}_{n + 1} , {y}_{n + 1} ) \leq λ ] = P r [ {y}_{n + 1} ∉ {𝒞}_{λ} ( {x}_{n + 1} ) ] .$$

Moreover, Q⁻¹ (λ, [symbol] _{calib}) is the miscoverage level for the label yₙ₊₁. The miscoverage level is within a bounded interval of length

$$\frac{1}{\vert {𝒟}_{calib} \vert + 1} .$$

For λ ∈ [0,1] and n=| [symbol] _{calib}|,

$$\frac{{\sum }_{i = 1}^{n} 1 [ s ( {x}_{i} , {y}_{i} ) > λ ]}{n + 1} < P r [ {y}_{n + 1} ∉ {𝒞}_{λ} ( {x}_{n + 1} ) ] < \frac{{\sum }_{i = 1}^{n} 1 [ s ( {x}_{i} , {y}_{i} ) > λ ] + 1}{n + 1} , \qquad ( 3 )$$

qzas: In standard CP, miscoverage is only evaluated for the true label, yᵢ. However, for fairness evaluation, it is essential to balance disparity between groups for all positive labels (see Table A1. So for conformal fairness evaluation, miscoverage needs to be balanced between groups for any given \tilde{y} ∈ [symbol] ⁺, as seen in Table 1. The example implementation can perform CP using a fixed label and get the same miscoverage guarantees. Equation 1 holds when {(xᵢ, yᵢ)} is replaced with {(xᵢ, \tilde{y})} for a fixed \tilde{y} ∈ [symbol] . Connecting Theory to the Framework: For a particular fairness metric, the study filtered the calibration set based on the conditional from Table 1 and achieved bounds on the conditional miscoverage. The bounds continue to hold when considering the conditional miscoverage for a fixed positive label. The study performed an inverse quantile to compute the miscoverage under various λ thresholds. With the miscoverages for a fixed positive label and each sensitive group, The example implementation can compute the worst pairwise coverage gap across the to evaluate and control fairness at the desired closeness criterion.

### Example Conformal Fairness (CF) Algorithm

Input: The input to the core CF algorithm (Algorithm 1), includes the calibration set, [symbol] _{calib}, the set of labels ( [symbol] ) and positive labels ( [symbol] ⁺), the set of sensitive groups, [symbol] , a closeness criterion, c, the threshold search space, Λ, a fairness metric, M, and a corresponding filter function, F_{M}. Choosing Λ: The algorithm accepts a user-provided search space, Λ, which avoids degenerate thresholds and can guarantee desirable conditions. The study set Λ=[\hat{q}(α), max{ [symbol] _{calib}}], ensuring that the optimal threshold, λₒₚₜ, is at least \hat{q}(α). Since λₒₚₜ≥\hat{q}(α), the miscoverage decreases for larger thresholds and still satisfies the a miscoverage requirement. That is,

$$Pr [ {y}_{n + 1} ∉ {𝒞}_{{λ}_{o p t}} ( {x}_{n + 1} ) ] \leq Pr [ {y}_{n + 1} ∉ {𝒞}_{\hat{q} ( α )} ( {x}_{n + 1} ) ] \leq α .$$

Procedure: For each λ ∈ Λ, the study checked if it balances the miscoverage between groups for all positive labels. So, for each (g, \tilde{y}) ∈ [symbol] × [symbol] ⁺, the example implementation used F_{M} to filter [symbol] _{calib} (Line 10 in Algorithm 1) and then compute the non-conformity scores, [symbol] _{calib}_{_{(g,\tilde{y})}} (Line 11). With the inverse quantile, the miscoverage level is computed at the A threshold on the scores (Line 13). The study then compared the miscoverages for a fixed y ∈ [symbol] ⁺ between groups and check if the worst-case disparity satisfies the desired closeness criterion (Lines 15-20), forming the set Λ_{M} (Line 2). The study chose

$${λ}_{o p t} = {min}_{λ} {Λ}_{M}$$

(Line 3) to minimize the final prediction set size (i.e. get the best efficiency). When evaluating multiple fairness metrics simultaneously, for example with Equalized Odds, the framework can be used to construct the set of satisfying lambdas for Equal Opportunity and Predictive Equality, Λ_{EO} and Λ_{PE} respectively. Then,

$${λ}_{o p t} = {min}_{λ} \{ {Λ}_{E O} ∩ {Λ}_{P E} \} .$$

Example Algorithm 1 Conformal Fairness Framework
procedure Conformal_Fairness ( [symbol] _{calib} , [symbol] , [symbol] ⁺, [symbol] , c, Λ, F_{M} )
Λ_{M} = {λ ϵ Λ | Satisfy_lambda ( [symbol] _{calib} , [symbol] , [symbol] ⁺, [symbol] , c, λ, F_{M} )}
${λ}_{opt} = {min}_{λ} {Λ}_{M}$
return λₒₚₜ
end procedure
procedure Satisfy_lambda ( [symbol] _{calib} , [symbol] , [symbol] ⁺, [symbol] , c, λ, F_{M})
label_miscoverages = [symbol]
interval_widths = [symbol]
for (g, \tilde{y}) ϵ [symbol] × [symbol] ⁺ do [symbol]
_{calib} _{_{(g,}}{tilde over (_{_{y}})}_{₎} = {(xᵢ, yᵢ) ϵ [symbol] _{calib} | F_{M}(xᵢ, yᵢ, g, \tilde{y}) = 1} [symbol]
_{calib}_{_{(g,}}{tilde over (_{_{y}})}_{₎} = {s(xᵢ, yᵢ) | (xᵢ, yᵢ) ϵ [symbol] _{calib}_{_{(g,}}{tilde over (_{_{y}})}_{₎}}
$interval\_widths [ ( g , \tilde{y} ) ] = \frac{1}{\vert {𝒟}_{calib ( g , \tilde{y} )} \vert + 1}$
label_miscoverages [(g, \tilde{y})] = Q⁻¹ (λ, [symbol] _{calib} _{_{(g,}}{tilde over (_{_{y}})}_{₎})
end for
for \tilde{y} ϵ [symbol] ⁺ do
αₘᵢₙ = min( label_miscoverages [(·, \tilde{y})] − interval_widths [(·, \tilde{y})])
αₘₐₓ = max( label_miscoverages [(·, y)])
if αₘₐₓ − αₘᵢₙ > c then return False
end if
end for
return True
end procedure

Using multiple λ thresholds: The study also considered a classwise approach where the study chose a

$$[ {λ}_{o p t}^{0} , … , {λ}_{o p t}^{k - 1} ] = {λ}_{o p t} ∈ {[ 0 , 1 ]}^{K}$$

for each of the K classes.

$${λ}_{o p t}^{i}$$

is only required to satisfy the closeness criterion for the i^{th} class. One can achieve this by setting y⁺={\tilde{y}} and repeating Lines 2 and 3 in Algorithm 1 for each \tilde{y} ∈y⁺. This allows for smaller

$${λ}_{o p t}^{i}$$

to be chosen for most classes as they are no longer impacted by minority classes which require a larger threshold to meet the closeness criterion.

A distinguishing feature of the CF framework is that it does not require group information at inference time. Though one can choose a different λ for each (g, y) ∈ [symbol] × [symbol] pair, in streaming (or online) settings the sensitive attribute may be unavailable. For example, loan applications may be race or gender-blind to enforce fairer judgment. In these settings, the CF Framework is not limited and provides group conditional coverage when group information is absent at inference time.

### Extensibility

Algorithm 1 directly applies to Demographic Parity, Equal Opportunity, Predictive Equality, and Equalized Odds. The following modifications are necessary to accommodate Disparate Impact, Predictive Parity, and some user-defined metrics.

Disparate Impact: The standard criterion for Disparate Impact is the Four-Fifths Rule (EEOC, 1979; Feldman et al., 2015) applied to Demographic Parity. To control the conditional coverages for the Four-Fifths Rule, the study only changed Line 18 in Algorithm 1 to check if (1−αₘₐₓ)/(1−αₘᵢₙ)<c for c=0.8.

Predictive Parity: Predictive Parity seeks to balance the Positive Predictive Value (PPV) between groups (Verma & Rubin, 2018). It differs from the other fairness metrics in Table 1 as it is conditioned on membership in the prediction set. Given the objective of balancing conditional coverage, the conformal definition of Predictive Parity, and Bayes' Theorem, it is obtained:

$$Pr [ Y = \tilde{y} \vert \tilde{y} ∈ {𝒞}_{λ} ( X ) , X ∈ {g}_{i} ] = {\underbrace{\frac{P r [ \tilde{y} ∈ {𝒞}_{λ} ( X ) \vert Y = \tilde{y} , X ∈ {g}_{i} ]}{P r [ \tilde{y} ∈ {𝒞}_{λ} ( X ) \vert X ∈ {g}_{i} ]}}}_{Equal Opportunity over Demographic Parity} \cdot {\underbrace{Pr [ Y = \tilde{y} \vert X ∈ {g}_{i} ]}}_{Conditional Label Probability} \qquad ( 4 )$$

for \tilde{y} ∈ [symbol] ⁺ and gᵢ ∈ [symbol] . A threshold, λ, is guaranteed to exist for any [symbol] ⁺⊆ [symbol] if c is greater than the maximum pairwise total variation distance of the group-conditioned label distribution. This is formalized in Theorem 3.4.

Theorem 3.4. Let W be a random variable for a label distribution over [symbol] . Let Wᵢ~W|(X ∈ gᵢ)—the label distribution conditioned on group membership. Then there exists λ such that for c≥max{D_{TV}(Wᵢ, Wⱼ)|i, j ∈ {1, . . . , | [symbol] |}}, where D_{TV} is the total variation distanc ¹} the difference in Predictive Parity between groups is within c.

In Equation 4, the Equal Opportunity, Demographic Parity, and Conditional Label Probability terms are all bounded within finite intervals. Thus, the example implementation can compute an interval for which conformal Predictive Parity is satisfied and use the CF framework to find λ s where the coverages satisfy the closeness criterion.

To control for arbitrarily small values of c, the study used the Predictive Parity Proxy-an example of a user-defined metric-defined in Equation 5. For all gᵢ ∈ [symbol] , \tilde{y} ∈ [symbol] ⁺,

$$Pr ( Y = \tilde{y} \vert \tilde{y} ∈ {𝒞}_{λ} ( X ) , X ∈ {g}_{i} ) - Pr ( Y = \tilde{y} \vert X ∈ {g}_{i} ) . \qquad ( 5 )$$

In cases where it is possible to assume the label distribution is independent of group membership, Equation 4 can be directly controlled for an arbitrarily small closeness criterion, c.

### Leveraging the CF Framework for Fairness Auditing

Using the Conformal Fairness Framework, one can audit if the disparity of a conformal predictor between multiple groups violates a user-specified fairness criterion. The study included an analysis of fairness criteria concerning bounding the disparity between groups using the fairness metrics described in Table 1 by some closeness criterion, c. It is straightforward to support userdefined fairness metrics concerning label coverage. While Algorithm 1, as presented, gives a method of finding an optimal λ threshold which satisfies the fairness guarantees using Lemmas 3.1, 3.2, and 3.3, the same Satisfy_Lambda procedure can be leveraged to check if a given λ used by a conformal predictor satisfies the same fairness guarantees. Notably, the CF framework can also be leveraged even if the conformal predictor is treated as a black-box model. In this case, we construct a [symbol] _{audit} set exchangeable with the calibration data used for the conformal predictor. Using [symbol] _{audit}, we can determine if the conformal predictor satisfies the corresponding fairness guarantee given the fairness metric and the λ threshold used.

### Non-Conformity Scores

There are several choices for the non-conformity score for performing fair conformal prediction with classification tasks. The example implementation can use TPS, APS, RAPS, DAPS, and CFGNN in the CF framework, though any non-conformity score can be used.

### Experiments

### Setup

Datasets: To evaluate the CF Framework, the study used five multi-class datasets Pokec-n, Pokec-z, Credit, ACSIncome, and ACSEducation (see Table 2 for details). For each dataset, the study used a 30%/20%/25%/25% stratified split of the labeled points for [symbol] ₜᵣₐᵢₙ/ [symbol] _{valid}/ [symbol] _{calib}/ [symbol] ₜₑₛₜ.

TABLE 2
Dataset Statistics.

| | | | # | # | # |
|---|---|---|---|---|---|
| Name | Type | Size | Labeled | Groups | Classes |
| ACSIncome | T | 1,664,500 | ALL | race(9) | 4 |
| ACSEducation | T | 1,664,500 | ALL | race(9) | 6 |

| | | | # | # | # |
|---|---|---|---|---|---|
| Name | Type | (\|ν\|, \|ε\|) | Labeled | Groups | Classes |
| Credit | T/G | (30, 000, 1, 436, 858) | ALL | age(2) | 4 |
| Pokec-n | G | (66, 569, 729, 129) | 8,797 | region(2), | 4 |
| | | | | gender(2) | |
| Pokec-z | G | (66, 569, 729, 129) | 8,797 | region(2), | 4 |
| | | | | gender(2) | |

T refers to Tabular and G refers to Graph.

Models: For the graph datasets, the study evaluated with GCN, GraphSAGE, or GAT as the base model (results reported are for the highest performing base model). For Credit, the study evaluated and additionally considered XGBoost (i.e., ignoring the graph structure) as empirically observed this approach to outperform the graph neural network baselines in terms of efficiency for this dataset. The choice of ignoring edge information while training Credit on XGBoost does not prevent using CFGNN or DAPS—which utilize the edge information. The conformal predictor simply requires the softmax logits from the base model (i.e. XGBoost) but is otherwise model agnostic. For ACSIncome and ACSEducation, the example implementation used an XGBoost model.

Baseline: For each dataset and CP non-conformity score, the study built a conformal predictor. Then, the study assesses fairness according to the specific fairness metric using the conformal quantile, \hat{q}, using the 90% quantile (α=0.1) from the calibration phase.

Evaluation Metrics: The study reports the worst fairness disparity and efficiency. For Disparate Impact, the worst fairness disparity is the minimum (1−αₘₐₓ)/(1−αₘᵢₙ) across the positive labels. For the remaining metrics, the example implementation records the maximum αₘₐₓ−αₘᵢₙ across the positive labels.

### Results

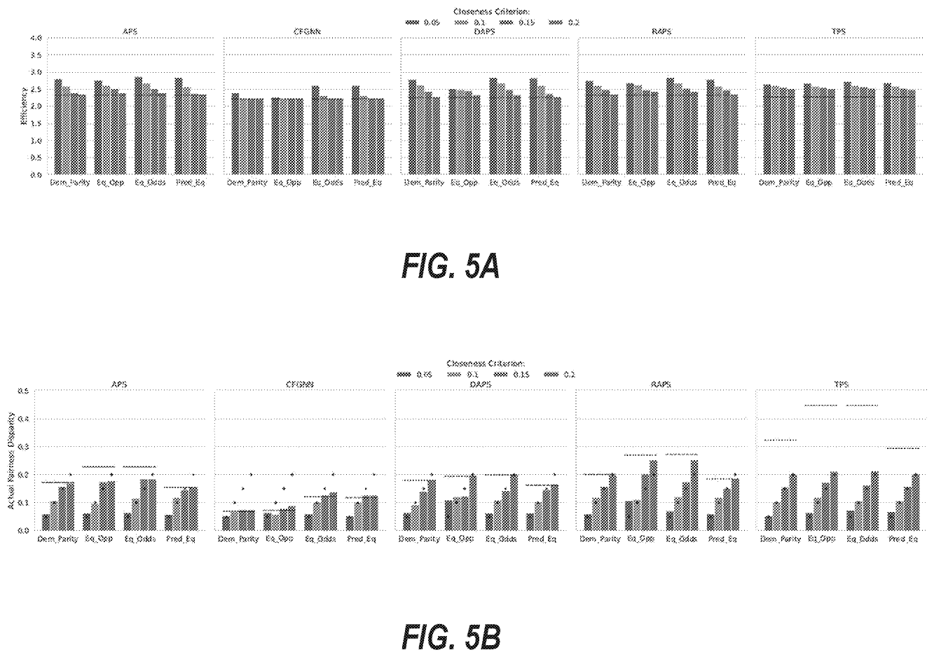

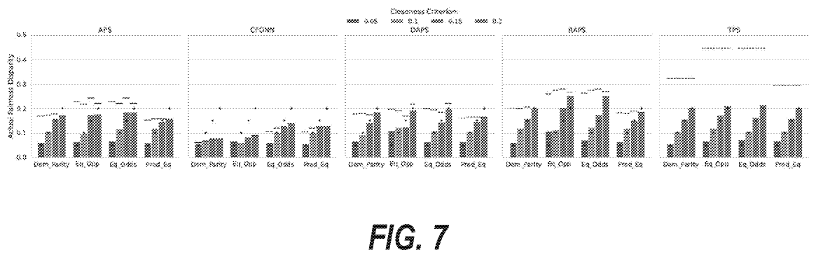

For each figure, a line indicates the base conformal predictor's average worst-case fairness disparity across different thresholds, the bar plot for the worst fairness disparity using the CF Framework, and a black dot to denote the desired fairness disparity. The study reports the average base performance for simplicity and readability of the figures. In every experiment, except for FIG. 5B, the CF framework was better than the average base conformal predictor. A more granular version of FIG. 5B is presented in FIG. 7, where it is clear that the framework performs better for every closeness threshold.

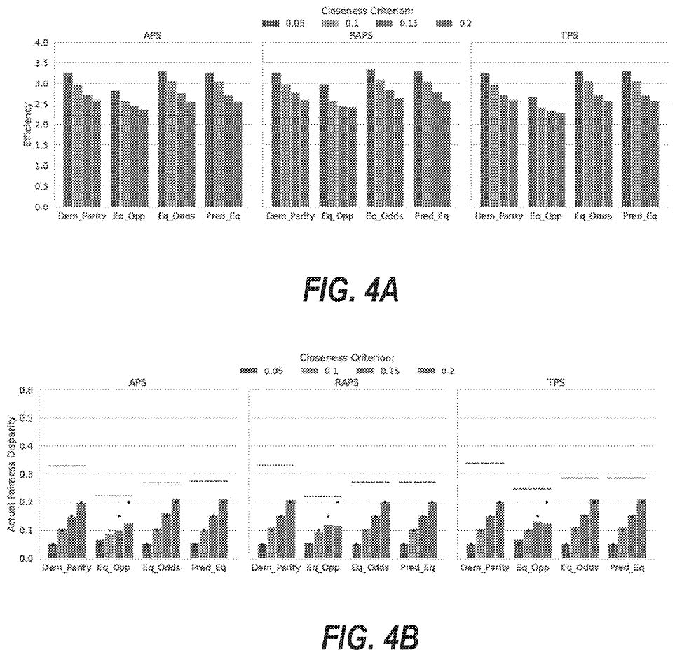

Controlling for Fairness Disparity: For different closeness thresholds, the example CF Framework effectively controls the fairness disparity for several metrics compared to the base conformal predictor. In FIGS. 4A-5B it is shown that in terms of fairness disparity, the example implementation of a CF Framework precisely (note step-wise change with c on violations) improves upon the baseline conformal predictor. FIG. 4A and FIG. 4B illustrate efficiency results and fairness disparities for an ACSIncome dataset. FIG. 5A and FIG. 5B illustrate efficiency results and fairness disparities for a Credit dataset. As with algorithmic fairness, a trade-off is involved in that there is a slightly worse efficiency. From FIGS. 5A-5B, the study continued to observe this for both standard and graph-based conformal predictors. Furthermore, if the base conformal predictor is already “fair” according to the fairness disparity criterion, then the CF Framework will report the results accordingly. This phenomenon is observed with the CFGNN results in FIGS. 5A-5B, where the CF Framework matches the baseline regarding both evaluation metrics. This behavior of the CF Framework makes it suitable to leverage for black box fairness auditing (as noted previously). The study herein presents additional results, for example, the disparity results for the CF Framework without classwise lambda. Notably, the prediction set sizes are more prominent due to selecting a larger λ than the classwise approach.

Controlling for Disparate Impact: For Disparate Impact, the study presents results for the standard 80% Rule. In Table 3, it is shown that using the CF Framework can significantly improve upon the base conformal predictor for the 80% Rule. For the base conformal predictor, the disparate impact value is far below the desired 0.8, and in some cases less than 0.4 as with Credit with TPS and ACSIncome dataset. The framework, however, is close to the 0.8 value and in some cases surpasses it, like in Credit with CFGNN, with minor effects on the efficiency for both datasets.

TABLE 3
80% Rule for Credit and ACSIncome. The example framework surpasses the base conformal
predictor and achieves close to or exceeds the disparate impact value of 0.80.

| | | APS | | RAPS | | TPS | | CFGNN | | DAPS | |
|---|---|---|---|---|---|---|---|---|---|---|---|
| | | Base | CF | Base | CF | Base | CF | Base | CF | Base | CF |
| Credit | Disp. | 0.646 | 0.821 | 0.586 | 0.768 | 0.352 | 0.793 | 0.922 | 0.922 | 0.539 | 0.809 |
| | Impact | | | | | | | | | | |
| | Efficiency | 2.326 | 2.513 | 2.326 | 2.509 | 2.368 | 2.558 | 2.302 | 2.302 | 2.354 | 2.526 |
| ACSIncome | Disp. | 0.397 | 0.797 | 0.387 | 0.790 | 0.356 | 0.798 | N/A | N/A | N/A | N/A |
| | Impact | 2.312 | 2.674 | 2.169 | 2.752 | 2.109 | 2.679 | N/A | N/A | N/A | N/A |
| | Efficiency | | | | | | | | | | |

Agnostic to Non-Conformity Score: As discussed earlier, the CF Framework can support a variety of non-conformity scores, emphasizing the agnostic nature of the example implementation. The example implementation achieved effective results for conformal predictors with different underlying non-conformity score functions for all the experiments.

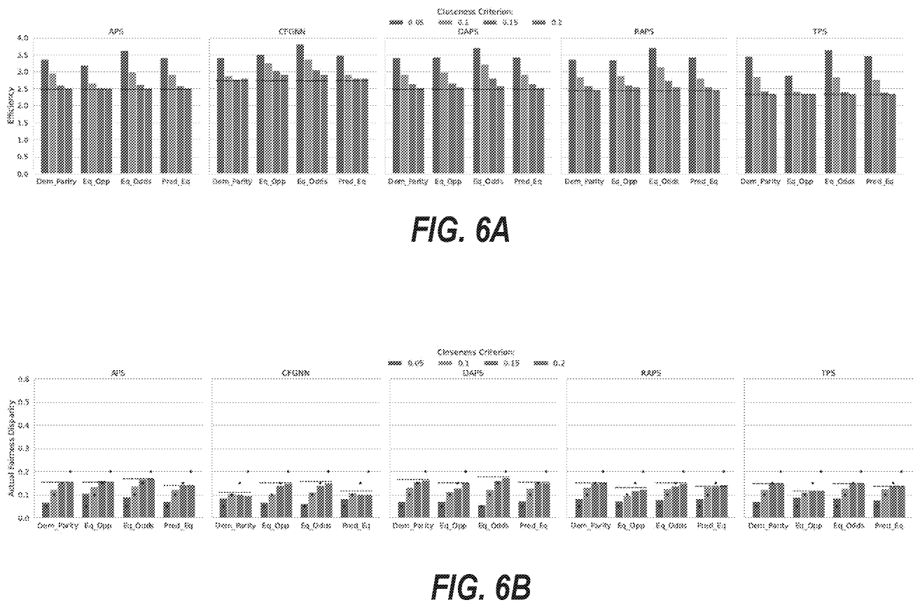

Intersectional Fairness: When characterizing data points into groups, the example implementation is not limited to a single sensitive attribute. In many applications, there can be multiple sensitive attributes (e.g., race and gender) that need to be considered. The example CF Framework is not limited to analyzing a single sensitive attribute. To demonstrate this, the study conducted an experiment with the Pokec-n dataset. Pokec-n has two sensitive attributes, namely region and gender. The study treated each combination of region and gender as a separate sensitive group and apply the CF framework to control for fairness disparities. FIGS. 6A-6B shows that the CF framework improves upon the base conformal predictor regarding fairness disparity. FIG. 6A illustrates plots efficiency and FIG. 6B illustrates plots of actual fairness disparity. This improvement is starker with the graph-based conformal predictors, CFGNN, and DAPS as seen in FIGS. 6A-6B.

One challenge intersectional fairness introduces is the multiplicative increase in the number of groups that must be calibrated and evaluated (combinations of sensitive attributes and classes). This places a stronger requirement on the number of data points necessary to meet the coverage guarantees described herein (guarantees are more challenging to meet as the size of D_{(g,y)} gets smaller). This problem is exacerbated (in empirical results) for datasets with only a few labeled points such as Pokec-n. For Pokec-n, using a standard data split, the calibration set has around 2200 data points. The calibration set is then further split to get the conditional positive label coverage for each positive label and group pair. This results in the calibration being done with sets of fewer than a few hundred points, which is much lower than the suggested 1000 points in the literature. In FIGS. 6A-6B, the effect of this challenge is seen with the fairness disparity given by the CF Framework being slightly above the desired closeness threshold for c=0.1. However, despite this disadvantage for many metrics, the guarantees are still being met, even for intersectional fairness.

Predictive Parity Proxy: As discussed, the CF framework is extensible to user-defined fairness notions. The Predictive Parity Proxy in Equation 5 is an example of a user's ability to provide a reasonable fairness measure (Disparate Impact, above is another example). An experiment on ACSEducation in Table 4 demonstrates the present disclosure can control for arbitrarily small values of c, unlike the standard notion of Predictive Parity. Additionally, it empirically illustrates that the present disclosure can control for disparities of probabilities conditioned on the prediction set. This metric can also be applied in the graph setting.

TABLE 4
ACSEducation. The worst-case fairness disparity, based on the Predictive
Parity Proxy, with the example implementation is below the desired
c threshold, while the avearge baseline disparity is much higher
(>0.30) than all of the c thresholds considered.

| | Closeness Threshold (c) | 0.05 | 0.10 | 0.15 | 0.20 | Base (Average) |
|---|---|---|---|---|---|---|
| APS | Max Fairness Disparity | 0.044 | 0.093 | 0.152 | 0.166 | 0.411 |
| | Efficiency | 3.662 | 3.336 | 3.049 | 3.008 | 2.982 |
| RAPS | Max Fairness Disparity | 0.043 | 0.094 | 0.153 | 0.172 | 0.368 |
| | Efficiency | 3.948 | 3.339 | 3.102 | 3.063 | 3.030 |
| TPS | Max Fairness Disparity | 0.038 | 0.091 | 0.167 | 0.199 | 0.319 |
| | Efficiency | 3.662 | 3.061 | 2.880 | 2.845 | 2.828 |

### Discussion

The example implementation enables formalizing Conformal Fairness using conformal predictors using a comprehensive Conformal Fairness (CF) Framework. The algorithms described herein are theoretically grounded and can be used to control for the gaps in conditional coverage, defined based on different fairness metrics, across sensitive groups. The present disclosure further shows results with conformal predictors for both tabular and graph datasets, leveraging the exchangeability assumption of (graph) conformal prediction. The results for Conformal Fairness based on various classical and user-defined fairness metrics on conformal predictors with various non-conformity score functions. The present study further presents results on the example implementation's effectiveness in evaluating intersectional fairness with conformal predictors, and describes how the CF framework can be practically leveraged for applications, including fairness auditing of conformal predictors. The present disclosure contemplates expanding the CF framework to control for coverage gaps for regression tasks and enhancing the theory to loosen assumptions of conformal prediction and look at non-exchangeable variations.

The example implementation improves on conventional concepts of auditing fairness of machine learning models. One line of work has focused on applying fairness notions toward CP problems for regression tasks, explicitly focusing on Demographic Parity respectively. Another line of work focuses on applying the notion of Overall Accuracy Equality for CP. An orthogonal direction is on (group) conditional CP.

The present disclosure improves on conventional techniques for fairness auditing of machine learning models by improving their breadth and flexibility and enabling a range of fairness metrics and conformity scores. The present disclosure further improves classification capabilities. Conventional approaches lack the guarantees of fairness described herein in the present disclosure's methods. The example CF framework presented herein generalizes group-balanced CP to consider the notion of coverage for a particular label, thus enabling evaluation of disparity based on classical fairness metrics in a manner that does not require apriori knowledge of group membership at inference time (or in an online setting), unlike many approaches listed above.

What is claimed is:

1. A computer-implemented method of improving fairness of a conformal predictor associated with a machine learning model, the method comprising:
receiving a calibration set comprising a plurality of subgroups;
receiving a fairness criterion;
receiving a set of thresholds for generating prediction sets by the conformal predictor;
iteratively determining whether a threshold from the set of thresholds balances coverage for each subgroup in the plurality of subgroups based on the fairness criterion; and
outputting an optimal threshold from the set of thresholds.

2. The computer-implemented method of claim 1, wherein receiving the fairness criterion comprises receiving a user selection of the fairness criterion.

3. The computer-implemented method of claim 1, further comprising outputting, to a user interface, at least one of (i) the optimal threshold or (ii) a measure of fairness corresponding to the optimal threshold.

4. The computer-implemented method of claim 1, wherein the fairness criterion comprises a closeness criterion that defines an allowed disparity between subgroup-conditional coverages or subgroup-conditional miscoverages.

5. The computer-implemented method of claim 4, wherein iteratively determining whether the threshold balances coverage comprises determining, for at least one label condition, a worst-case pairwise disparity in subgroup-conditional miscoverage or subgroup-conditional coverage across the plurality of subgroups and comparing the worst-case pairwise disparity to the closeness criterion.

6. The computer-implemented method of claim 5, wherein the fairness criterion comprises disparate impact and the closeness criterion comprises a ratio criterion comparing subgroup-conditional coverages between subgroups.

7. The computer-implemented method of claim 1, further comprising determining a plurality of classwise optimal thresholds that respectively correspond to different classes.

8. The computer-implemented method of claim 1, wherein iteratively determining whether the threshold balances coverage comprises filtering the calibration set into a plurality of filtered calibration subsets based on a condition associated with the fairness criterion, the plurality of filtered calibration subsets including subsets corresponding to different subgroups, and wherein at least one subgroup comprises an intersectional subgroup defined as a combination of values of multiple sensitive attributes.

9. The computer-implemented method of claim 6, further comprising:
computing non-conformity scores for at least one filtered calibration subset using a non-conformity score function; and
computing a subgroup-conditional miscoverage level for the threshold based on an inverse quantile evaluation of the non-conformity scores,
wherein the non-conformity score function comprises at least one of threshold prediction sets (TPS), adaptive prediction sets (APS), regularized adaptive prediction sets (RAPS), diffusion adaptive prediction sets (DAPS), or conformalized graph neural networks (CFGNN).

10. The computer-implemented method of claim 1, wherein the set of thresholds comprises a threshold search space having a lower bound determined from a conformal quantile corresponding to a target miscoverage bound.

11. The computer-implemented method of claim 1, wherein the optimal threshold is selected to balance miscoverage between the plurality of subgroups.

12. The computer-implemented method of claim 1, wherein the optimal threshold is selected to minimize an average prediction set size.

13. The computer-implemented method of claim 1, further comprising receiving a plurality of fairness metrics, and wherein outputting the optimal threshold comprises outputting a threshold that satisfies the plurality of fairness metrics.

14. The computer-implemented method of claim 1, wherein the fairness criterion corresponds to at least one of demographic parity, equal opportunity, predictive equality, equalized odds, predictive parity, disparate impact, or a user-defined fairness metric.

15. A computer-implemented method of claim 1, further comprising:
receiving a trained machine learning model;
calibrating or configuring a conformal predictor associated with the trained machine learning model using the optimal threshold; and
operating the trained machine learning model in inference mode to output, for an input, a prediction set generated using the optimal threshold.

16. The computer-implemented method of claim 15, wherein the prediction set is generated using a single threshold without requiring subgroup membership information for the input during inference.

17. A computer-implemented method for auditing fairness of a conformal predictor of a deployed machine learning model, the method comprising:
receiving a fairness criterion;
receiving a threshold used by the conformal predictor to generate prediction sets;
receiving an audit dataset exchangeable with calibration data used by the conformal predictor;
determining, using the audit dataset, whether the conformal predictor satisfies the fairness criterion at the threshold; and
outputting an audit result indicating whether the fairness criterion is satisfied.

18. The computer-implemented method of claim 17, wherein determining whether the conformal predictor satisfies the fairness criterion is performed while treating the conformal predictor as a black box.

19. A system comprising:
a first computing device configured to operate a trained machine learning model in inference mode;
a second computing device in operative communication with the first computing device, wherein the second computing device is configured to audit the trained machine learning model by:
receiving a calibration set comprising a plurality of subgroups;
receiving a fairness criterion;
receiving a set of thresholds for generating prediction sets by a conformal predictor;
iteratively determining whether a threshold from the set of thresholds balances coverage for each subgroup in the plurality of subgroups based on the fairness criterion;
outputting an optimal threshold from the set of thresholds;
calibrating or configuring a conformal predictor associated with the trained machine learning model using the optimal threshold; and
operating the trained machine learning model in inference mode to output, for an input, a prediction set generated using the optimal threshold.

20. The system of claim 19, further comprising a display, wherein the second computing device is configured to output an indication of whether the trained machine learning model satisfies the fairness criterion.
